(19) United States
(12) Patent Application Publication
(10) Pub. No.: US 2018/0241475 A1
(43) Pub. Date: Aug. 23, 2018

(54) WIRELESS OPTICAL COMMUNICATION SYSTEM AND OPTICAL TRANSMITTER THEREOF

(71) Applicant: National Taipei University of Technology, Taipei (TW)

(72) Inventors: Hai-Han Lu, Taipei (TW); Chung-Yi Li, Taipei (TW)

(21) Appl. No.: 15/601,000

(22) Filed: May 22, 2017

(30) Foreign Application Priority Data
Feb. 17, 2017 (TW) 106105397

(51) Int. Cl. H04B 10/516; H04B 10/80; H04B 10/11

(52) U.S. Cl. CPC H04B 10/516; H04B 10/11; H04B 10/80

(57) ABSTRACT

A wireless optical communication system including an optical transmitter and an optical receiver is provided. The optical transmitter is configured to receive a first data, to perform modulation on the first data and to generate a data optical wave based on the modulated first data, wherein the optical transmitter applies a two-stage injection lock means for generating and emitting an output optical signal based on the data optical wave. The optical receiver is configured to receive the output optical signal, to convert the output optical signal into an electrical signal, followed by performing demodulation on the electrical signal in order to generate a second data corresponding to the first data. The configuration of an optical transmitter applied to the wireless optical communication system is also provided.

### BACKGROUND OF THE INVENTION

### Field of the Invention

The present invention is related to a wireless optical communication system and an optical transmitter thereof, in particular, to a wireless optical communication system and an optical transmitter thereof applied to underwater communications.

### Description of Related Art

Traditionally, the common communication techniques for underwater operation include two main types of methods, which are the wired transmission and wireless transmission. However, it is known that for the wired transmission method, the transmission distance is restricted by the hardware factors of the cable layout concern etc.; whereas for the currently existing wireless methods of sonar or ultrasonic wave etc., since it is of low-order rate of change under the water, the transmission stability is affected.

In recently years, the development of optical communication technology is becoming more mature, and the application of optical communication technology has also become the key focus for researchers in various fields, especially for the underwater communication application where the optical communication can have a high transmission rate. In comparison to radio-frequency and acoustic communications, the underwater optical communication system is of much higher transmission bandwidth such that the entire system can have a higher data transmission rate. Consequently, such systems are mostly used in monitoring environment, and numerous under wireless optical communication systems for underwater oil pipe investigation or other underwater exploration have be proposedly one after another. With the rapid development of underwater optical communication system, the demands for underwater communications of long range, fast and high data transmission rate are becoming the main focuses of the technology development.

### SUMMARY OF THE INVENTION

The present invention provides a wireless optical communication system and an optical transmitter thereof, which are able to achieve underwater wireless communications of long range and high data transmission rate.

Accordingly, a wireless optical communication system of the present invention comprises an optical transmitter and an optical receiver. The optical transmitter is configured to receive a first data, to perform a modulation on the first data and to generate a data optical wave based on the modulated first data; wherein the optical transmitter applies a two-stage injection lock means for generating and emitting an output optical signal according to the data optical wave. The optical receiver is configured to receive the output optical signal and to convert the output optical signal into an electrical signal, followed by performing a modulation on the electrical signal in order to generate a second data corresponding to the first data.

In addition, accordingly, a wireless optical communication transmitter of the present invention comprises a modulation circuit, a first optical transmission unit, a second optical transmission unit and a third optical transmission unit, a first injection lock circuit and a second injection lock circuit. The modulation circuit is configured to perform a modulation on a first data in order to generate a modulation signal. The first optical transmission unit is coupled to the modulation circuit and is configured to excite and emit a data optical wave having a first wavelength based on the modulation signal. The second optical transmission unit is configured to excite and emit a first predefined optical wave having a second wavelength. The third optical transmission unit is configured to excite and emit a second redefined optical wave having a third wavelength. The first injection lock circuit is coupled to the first optical transmission unit and the second optical transmission unit, and it is configured to adjust a polarization of the data optical wave and to couple the data optical wave with the first predefined optical wave in order to generate a first optical signal having a mode-locked characteristic. The second injection lock circuit is coupled to the first injection lock circuit and the third optical transmission unit, and it is configured to adjust a polarization direction of the second predefined optical wave and to couple the second predefined optical wave with the first optical signal in order to generate an output wave signal having a mode-lock characteristic.

In view of the above, according to an embodiment of the present invention, a wireless optical communication system and an optical transmitter thereof is are provided, which are able to apply a two-stage injection lock means in order to obtain a transmitted optical wave having a preferred frequency response characteristic to be used a transmission signal; therefore, the wireless optical communication system in this embodiment is able to have a relatively higher data transmission rate. As a result, an underwater optical communication system having a high data transmission rate and a long range (greater than 8 m) can be achieved.

To further illustrate the aforementioned characteristics and advantages of the present invention, the following description provides embodiment of the present invention along with the accompanied drawings in detail.

### BRIEF DESCRIPTION OF DRAWING

FIG. 1 is a schematic view of a system structure of the wireless optical communication system according to an embodiment of the present invention;

FIG. 2 is a schematic view of a structure of the optical transmitter according to an embodiment of the present invention;

FIGS. 3A and 3B show schematic views of structures of the injection lock circuits according to an embodiment of the present invention; and

FIG. 4 is a schematic view of a structure of the optical receiver according to an embodiment of the present invention.

### DETAILED DESCRIPTION OF THE INVENTION

To facilitate the understanding of the content disclosed in the present application, the following provides examples of embodiments of the present invention capable of being implemented in practice. In addition, in the accompanied drawings and embodiments, elements/part/steps labeled with identical signs and symbols shall refer to identical or similar parts.

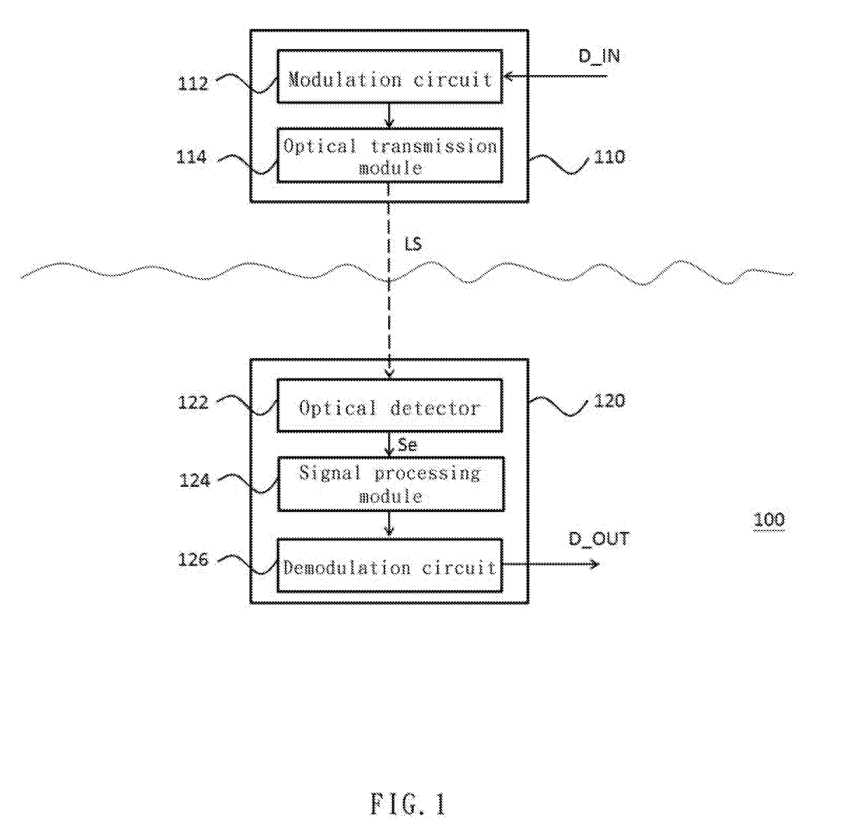

FIG. 1 shows a schematic view of a system structure of a wireless optical communication system according to an embodiment of the present invention. As shown in FIG. 1, a wireless optical communication system 100 comprises an optical transmitter 110 and an optical receiver 120. The optical transmitter 110 is configured to receive an input data D_IN (such as: encoded data) and to perform a modulation on the input data D_IN, followed by generating an output optical signal LS for emitting into the environment based on the modulated input data D_IN. In other words, the input data D_IN can undergo digital or analogue modulation in order to use optical wave as the carrier, and the modulated input data can be carried on the carrier in order to form the output optical signal LS.

The optical receive 120 is configured to collect the optical wave from the environment and to convert the output optical signal LS therein into an electrical signal Se; in addition, it then also performs amplification and signal processing of equalization etc. on the electrical signal Se, followed by performing modulation on the processed electrical signal in order to generate an output data D_OUT corresponding to the input data D_IN.

In this embodiment, the wireless optical communication system 100 can be utilized in the applications of indoor multi-point positioning, signal broadcasting, remote sensor application service and underwater communication applications etc. For the application of underwater communication, since the blue laser has the characteristic of relatively small loss in the water, the output optical signal LS generated by the optical transmitter 110 in this embodiment can be a blue laser of preferably a wavelength of approximately 405 nm; however, the present invention is not limited to such wavelength only.

Specifically, the optical transmitter 110 comprises a modulation circuit 112 and an optical transmission module 114. The modulation circuit 112 is used for performing a modulation on the input data D_IN in order to generate a modulated signal Smd, wherein the modulation circuit 112 can use the analogue modulation method of such as the Phase Modulation (PM), Frequency Modulation (FM) and Amplitude Modulation (AM) etc., or it can use the digital modulation method of such as the Amplitude-Shift Keying (ASK), Phase-Shift Keying (PSK), Quadrature Amplitude Modulation (QAM), Frequency-Shift Keying (FS) and Orthogonal Frequency Division Modulation (OFDM) etc. in order to perform modulation on the input data D_IN. In this embodiment, the modulation circuit 110 can use, for example, a 16QAM-OFDM to generate the modulation signal Smd; however, the present invention is not limited to such method only. In addition, the frequency of the modulation signal Smd in this embodiment can be, for example, 5 GHz, and the sampling rate can b, for example, 9.6 Gbps; nevertheless, again, the present invention is not limited to such values only.

The optical transmission module 114 is coupled to the modulation circuit 112 and it is able to generate a corresponding data optical wave SLd based on the modulation signal Smd received, meaning that the electrical signal is converted into the form of optical wave. In this embodiment, the optical transmitter 110 uses a two-stage injection lock means in order to generate and to emit the output optical signal LS based on the data optical wave SLd. To be more specific, during the use of the two-stage injection lock means, the optical transmission module 114 is able to perform a first-stage injection lock based on the data optical wave and a predefined optical wave in order to generate a first optical signal, wherein the first optical signal carries the information of the data optical wave and is of the mode-lock characteristic due to the effect of injection lock such that the signal wavelength is maintained at a particular wavelength. Next, the optical transmission module 114 then performs a second-stage injection lock based on the first optical signal and another predefined wavelength in order to generate an output optical signal LS having a mode-lock characteristic.

The optical receiver 120 comprises an optical detector 122, a signal processing module 124 and a demodulation circuit 126. The optical detector 122 is configured to convert the optical signal received into an electrical signal. In an actual application, the optical detection 122 can be implemented as a photodiode, and it can convert the optical signal into the electrical signal through the method of absorbing and detecting photons as well as generating a corresponding photocurrent.

The signal processing module 124 is coupled to the photo detector 122 and is configured to perform the process of, such as, amplification and equalization etc. on the electrical signal Se received from the optical detector 122 in order to generate a baseband signal Sb.

The demodulation circuit 126 is coupled to the signal processing module 124 and is configured to perform modulation on the baseband signal Sb in order to generate an output data D_OUT corresponding to the input data D_IN. In addition, the demodulation circuit 126 is arranged corresponding to the modulation circuit 112, meaning that the two uses the corresponding modulation and demodulation means.

In terms of the overall system operation, at the transmission end, after the data to be transmitted is encoded, it is loaded onto the modulation circuit 112 for conversion into a variable current changing along with the signal in order to drive the light source in the optical transmission module 114, referring to the conversion of the electrical signal into the output optical signal LS. Then, the optical transmission module 114 then adopts the optical transmission means of using lenses etc. to output the optical signal LS for transmission in the channel in a parallel beam form. Moreover, for the reception end, the optical receiver 120 is able to focus the parallel beam transmitted via the optical receiving means of lenses etc. onto the optical detector 122 in a point-light source form. Subsequently, the optical detector 122 is able to convert the optical signal received into electrical signal, and the signal processing module 124 is able to perform signal processing. Finally, the demodulation circuit 126 demodulates it into the original information.

In comparison to the traditional acoustic communication system, during the time when the wireless optical communication system 100 in this embodiment is applied in the underwater communication, it is able to overcome the drawbacks of narrow bandwidth, great influence by the environment, low applicable carrier frequency and high transmission latency etc. associated with the underwater acoustic communication. Specifically, for the wireless optical communication system 100 in this embodiment, since the frequency of light is high, the information carrying ability is great and wireless communication links of large capacity can be constructed, high speed transmission of large information capacity data under the water can be achieved. Moreover, since the optical communication is of great anti-electromagnetic interference ability and is not likely to be affected by the water temperature and salinity of sea water, the optical communication can have a relatively longer effective transmission distance.

Furthermore, the application of the two-stage injection lock means to generate an output optical signal is able to allow the output optical signal LS generated by the optical transmitter 110 in this embodiment to have a greater frequency response characteristic. In accordance with the verification of experiment data, the use of blue laser along with the use of the optical transmitter 110 in which the two-stage injection lock means is applied, the output optical signal LS thereof can have a bandwidth reaching 5.4 GHz. Accordingly, the optical signal LS outputted can have a relatively higher information transmission rate.

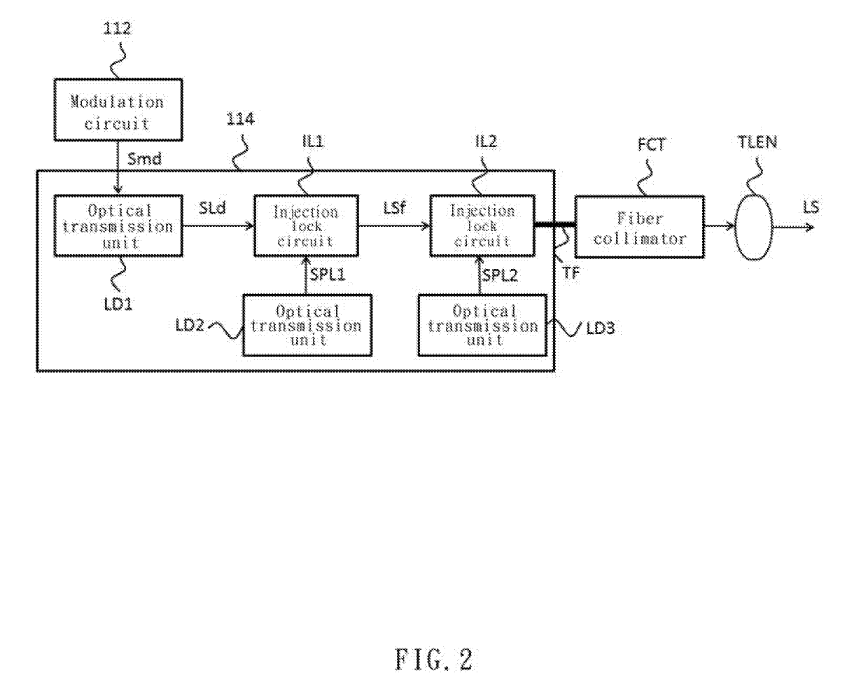

FIG. 2 shows a schematic view of a structure of the optical transmitter according to an embodiment of the present invention. As shown in FIG. 2, the optical transmitter 110 comprises a modulation circuit 112 and an optical transmission module 114; wherein the optical transmission module 114 comprises optical transmission units LD1˜LD3 and injection lock circuits IL1 and IL2. In addition, to allow the output optical signal LS transmitted to be transmitted in a greater medium, in an exemplary embodiment, the optical transmission module 114 can further comprise a transmission fiber TF, a fiber collimator FCT and a transmission lens set TLEN.

In the optical transmission module 114, the optical transmissions LD1˜LD3 can be, for example, laser diodes, which are able to excite and emit a laser light of a particular wavelength (such as blue wavelength). In addition, the optical transmission unit LD1 is coupled to the modulation circuit 112 and is configured to excite and emit a data optical wave SLd having a first wavelength based on the modulation signal Smd (said second wavelength can be, for example, 404.9 nm; however, the present invention is not limited to such wavelength only). The optical transmission unit LD3 is configured to excite and emit the second predefined optical wave SPL 2 having a third wavelength (said third wavelength can be, for example, 405 nm; however, the present invention is not limited to such wavelength only).

The injection lock circuit IL1 is coupled to the optical transmission units LD1 and LD2 and is configured to adjust a polarization direction of the data optical wave SLd and to couple the data optical wave SLd with the predefined optical wave in order to generate an optical signal LSf having a mode-locking characteristic. The injection lock circuit IL2 is coupled to the output of the injection lock circuit IL1 and the optical transmission unit LD3 and is configured to adjust a polarization direction of the predefined optical wave SPL2 and to couple the predefined optical wave SPL2 with the optical signal LSf in order to generate an output optical signal LS having a mode-locking characteristic. In other words, in the optical transmission module 114, the optical transmission unit LD1 and LD2 as well as the injection lock circuit IL1 execute the injection lock action of the first level/first stage in order to generate the optical signal LSf. In addition, the injection lock circuits IL1 and IL2 as well as the optical transmission unit LD3 execute the injection lock action of the second level/second stage in order to generate the output optical signal LS.

The transmission fiber TF is coupled to the output end of the injection lock circuit IL2 and is configured to provide a light transmission path for the output optical signal LS in order to transmit the output optical signal LS to the optical collimator FCT at the rear end. The optical collimator FCT receives the output optical signal LS via the transmission fiber TF and is configured to collimate the output optical signal LS in order to adjust the scattered directions of the output optical signal LS into a collimated optical beam. The transmission lens set TLEN is arranged on the light transmission path of the fiber collimator FCT and is configured to transmit the output optical signal LS collimated in a parallel light form.

In this embodiment, the operating wavelength range can be, for example, between 395-415 nm, and the diameter of the collimated optical beam after collimation can be, for example, 0.7 nm, and the focal distance thereof is 4.02 mm; however, the present invention is not limited to such values only. In addition, the transmission lens set TLEN can be, for example, implemented as a double convex lens; however, again, the present invention is not limited to such type only.

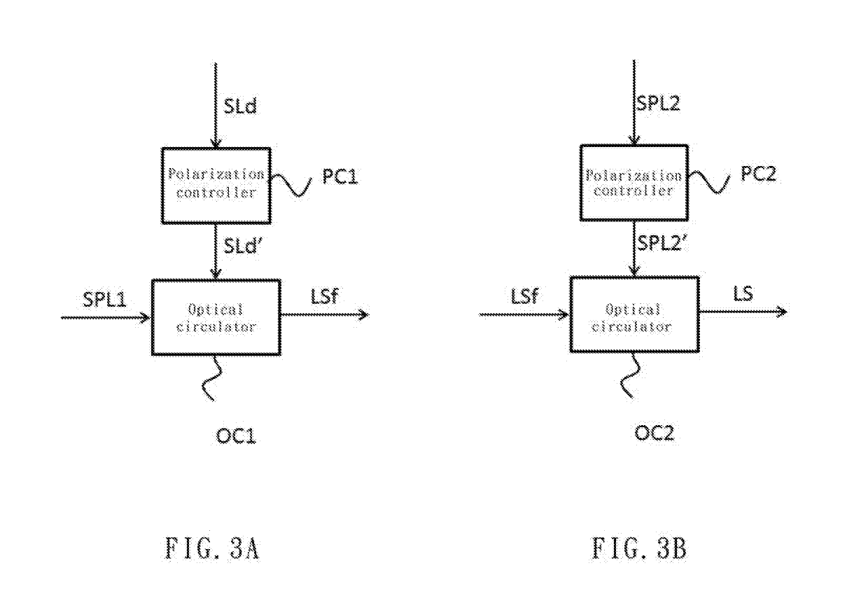

The following provides further explanations on the structure and operation of the injection lock circuits IL1 and IL2 in accordance with FIG. 3A and FIG. 3B. FIG. 3A and FIG. 3B show schematic views of structures of the injection lock circuits according to an embodiment of the present invention. First, as shown in FIG. 3, the injection lock circuit IL1 comprises a polarization controller (PC1) and an optical circulator (OC1). The polarization controller PC1 is coupled to the optical transmitter unit LD1 and is configured to adjust the polarization direction of the data optical wave SLd. The optical circulator OC1 is coupled to the optical transmission unit LD2 and the polarization controller PC1, and it is configured to guide the optical transmission directions of the data optical wave SLd′ after polarization adjustment and the predefined optical wave SPL1. The optical circulator OC1 is coupled to the optical transmission unit LD2 and the polarization controller PC1, and it is configured to guide the optical transmission directions of the data optical wave SLd′ after polarization adjustment and the predefined optical wave SPL1 in order to provide an injection path for coupling the data optical wave SLd′ and the predefined optical wave SPL1 as well as generating an optical signal LSf accordingly. Moreover, the optical circular OC1 can include, for example, an optical isolator and a ½ optical splitter, and the operating wavelength of the optical isolator can be 405 nm.

Please refer to FIG. 3B, the injection lock circuit IL2 comprises a polarization controller PC2 and an optical circulator OC2. The polarization controller PC2 is coupled to the optical transmission unit LD3 and is configured to adjust the polarization direction of the predefined optical wave SPL2. The optical circulator OC2 is coupled to the optical circulator OC1 and the polarization controller PC2, and it is configured to guide the optical transmission directions of the predefined optical wave SPL2′ after polarization and the optical signal LSf in order to provide an injection path for coupling the predefined optical wave SPL2′ and the optical signal LSf as well as generating the output optical signal LS.

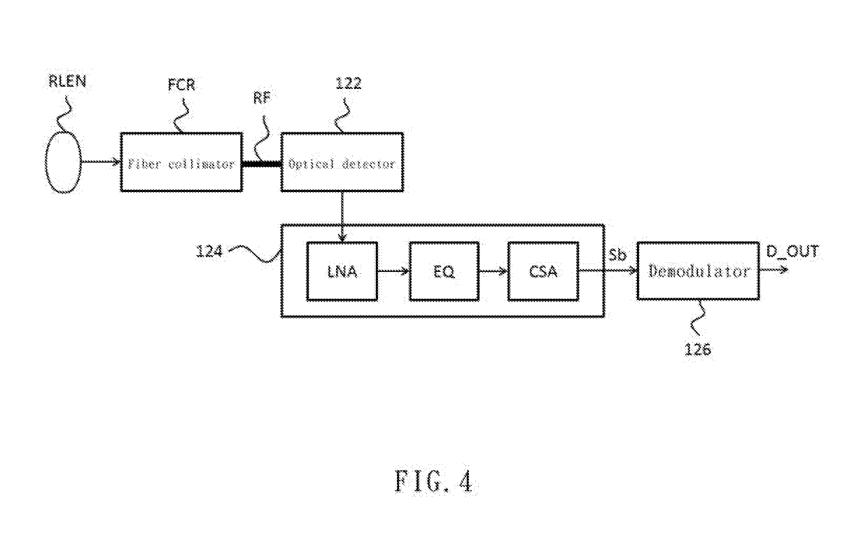

FIG. 4 shows a schematic view of the optical receiver according to an embodiment of the present invention. As shown in FIG. 4, the optical receiver comprises an optical detector 122, a signal processing module 124 and a demodulation circuit 126. The optical detector 122 is configured to convert the input optical signal LR received into an electrical signal Se. In this embodiment, the optical detector 122 can be, for example, a photodiode, and it is able to convert the photon quantity received into corresponding photocurrent (i.e., said electrical signal Se); however, the present invention is not limited to such configuration only.

The signal processing module 124 is coupled to the optical detector 122 and is configured to perform signal processing on the electrical signal Se received from the optical detector 122 in order to generate a baseband signal Sb. In this embodiment, the signal processing module 124 can include, for example, a Low Noise Amplifier (LNA), an Equalizer (EQ) and a Communication Signal Analyzer (CSA). The low noise amplifier (LNA) is able to amplify the electrical signal Se received, followed by transmitting it to the equalizer (EQ) to perform equalization process. Next, the communication signal analyzer (CSA) is able to extract the baseband signal Sb from the equalized electrical signal Se.

The demodulator circuit 126 is coupled to the signal processing module 124 and is able to perform signal analysis on the baseband signal Sb in order to obtain a Bit Error Rate (BER) and to generate a corresponding constellation diagram, following which it can then perform demodulation on the baseband signal Sb in order to generate the output data D_OUT.

In addition, to receive the output optical signal LS transmitted by the optical transmitter 110 better, I nan exemplary embodiment, the optical receiver 120 can further include a receiving lens set RLEN, a fiber collimator FCR and a receiving fiber RF. The receiving lens set RLEN is configured to collect light beams and to generate an input optical signal LR accordingly. Moreover, the receiving lens set RLEN is able to focus the light beam received onto a focal point in order to transmit it to the fiber collimator FCR arranged on the light transmission path. The fiber collimator FCR is configured to collimate the input optical signal LR and to provide the collimated input optical signal LR via the receiving fiber RF.

In view of the above, the embodiments of the present invention provide a wireless optical communication system and an optical transmitter thereof, which is able to apply the two-stage injection lock means to obtain a transmission optical wave having a greater frequency response characteristic as the transmission signal in order to allow the wireless optical communication system in this embodiment to have a relatively higher data transmission rate. Accordingly, an underwater wireless optical communication system of a high data transmission arte and a long range (over 8 m) can be achieved.

It can be understood that although the present invention has been illustrated with preferred embodiments as disclosed above, such embodiments shall not be used to limit the present invention. Any person skilled in the art in this field is able to make modifications and refinements without deviating the spirit and scope of the present invention. Therefore, the scope of the present invention shall be based on the claims recited hereafter.

What is claimed is:

1. A wireless optical communication system, comprising
an optical transmitter configured to receive a first data, to perform a modulation on the first data and to generate a data optical wave based on the modulated first data;
wherein the optical transmitter applies a two-stage injection lock means for generating and emitting an output optical signal according to the data optical wave; and
an optical receiver configured to receive the output optical signal and to convert the output optical signal into an electrical signal, followed by performing a modulation on the electrical signal in order to generate a second data corresponding to the first data.

2. The wireless optical communication system according to claim 1, wherein the optical transmitter comprises:
a modulation circuit for performing a modulation on the first data in order to generate a modulation signal; and
an optical transmission module coupled to the modulation circuit and configured to generate the data optical wave based on the modulation signal; wherein the optical transmission module performs a first-stage injection lock based on the data optical wave and a first predefined optical wave in order to generate a first optical signal as well as performs a second-stage injection lock based on the first optical wave signal and a second predefined optical wave in order to generate the output optical signal.

3. The wireless optical communication system according to claim 2, wherein the modulation signal uses a 16-QAM-orthogonal frequency-division multiplexing (OFDM) to perform the modulation on the first data.

4. The wireless optical communication system according to claim 2, wherein the modulation signal is of a frequency of 5 GHz, and the sampling rate is 9.6 Gbps.

5. The wireless optical communication system according to claim 2, wherein the optical transmission module comprises:
a first optical transmission unit coupled to the modulation circuit and configured to transmit the data optical wave having a first wavelength based on the modulation signal;
a second optical transmission unit configured to excite and emit the first predefined optical wave having a second wavelength;
a third optical transmission unit configured to excite and emit the second predefined optical wave having a third wavelength;
a first injection lock circuit coupled to the first optical transmission unit and the second optical transmission unit, configured to adjust a polarization direction of the data optical wave and to couple the data optical wave with the first predefined optical wave in order to generate the first optical signal having a mode-locked characteristic; and
a second injection circuit coupled to the first injection lock circuit and the third optical transmission unit, configured to adjust a polarization direction of the second predefined optical wave and to couple the second predefined optical wave and the first optical signal in order to generate the output optical signal having a mode-locked characteristic.

6. The wireless optical communication system according to claim 5, wherein the first injection lock circuit comprises:
a first polarization controller coupled to the first optical transmission unit and configured to adjust a polarization direction of the data optical wave; and
a first optical circulator coupled to the second optical transmission unit and the first polarization controller as well as configured to guide optical transmission directions of the data optical wave and the first predefined optical wave in order to provide an injection path for coupling the data optical wave with the first predefined optical wave and to generate the first optical signal accordingly.

7. The wireless optical communication system according to claim 6, wherein the second injection lock circuit comprises:
a second polarization controller coupled to the third optical transmission unit and configured to adjust a polarization direction of the second predefined optical wave; and
a second optical circulator coupled to the first optical circulator and the second polarization controller as well as configured to guide optical transmission directions of the second predefined optical wave and the first optical signal in order to provide an injection path for coupling the second predefined optical wave with the first optical signal and to generate the output optical signal accordingly.

8. The wireless optical communication system according to claim 7, wherein the optical transmission module further comprises:
a transmission fiber coupled to an output end of the second optical circulator and configured to transmit the output optical signal;
a fiber collimator for receiving the output signal from the transmission fiber and configured to transmit the output optical signal collimated.

9. The wireless optical communication system according to claim 5, wherein the first wavelength is 404.97 nm, the second wavelength is 404.99 nm and the third wavelength is 405 nm.

10. The wireless optical communication system according to claim 1, wherein the optical receiver comprises:
an optical detector configured to convert an optical signal received into an electrical signal;
a signal processing module coupled to the optical detector and configured to process the electrical signal received from the optical detector in order to generate a baseband signal; and
a demodulation circuit coupled to the signal processing module and configured to perform a demodulation on the baseband signal in order to generate the second data.

11. The wireless optical communication system according to claim 10, wherein the optical receiver comprises:
a receiving lens set configured to collect light and to generate an input optical signal accordingly;
a fiber collimator arranged on a light transmission path of the receiving lens set and configured to collimate the input optical signal; and
a receiving fiber coupled to the fiber collimator and an input end of the optical detector as well as configured to transmit the collimated input optical signal to the optical detector.

12. The wireless optical communication system according to claim 1, wherein the output optical signal is a blue laser.

13. A wireless optical communication transmitter, comprising:
a modulation circuit configured to perform a modulation on a first data in order to generate a modulation signal;
a first optical transmission unit coupled to the modulation circuit and configured to excite and emit a data optical wave having a first wavelength based on the modulation signal;
a second optical transmission unit configured to excite and emit a first predefined optical wave having a second wavelength;
a third optical transmission unit configured to excite and emit a second redefined optical wave having a third wavelength;
a first injection lock circuit coupled to the first optical transmission unit and the second optical transmission unit, configured to adjust a polarization of the data optical wave and to couple the data optical wave with the first predefined optical wave in order to generate a first optical signal having a mode-locked characteristic; and
a second injection lock circuit coupled to the first injection lock circuit and the third optical transmission unit, configured to adjust a polarization direction of the second predefined optical wave and to couple the second predefined optical wave with the first optical signal in order to generate an output wave signal having a mode-lock characteristic.
